(19) United States
(12) Patent Application Publication
(10) Pub. No.: US 2025/0018618 A1
(43) Pub. Date: Jan. 16, 2025

(54) Waterproof Heating Pad And Method Of Manufacturing Same

(71) Applicant: HeatTrak, LLC, Doraville, GA (US)

(72) Inventor: Hillel Glazer, Doraville, GA (US)

(21) Appl. No.: 18/768,139

(22) Filed: Jul. 10, 2024

Related U.S. Application Data
(60) Provisional application No. 63/526,026, filed on Jul. 11, 2023.

(51) Int. Cl. B29C 41/30; B29C 41/28; B29C 63/02; B29L 7/00; B29L 31/34

(52) U.S. Cl. CPC B29C 41/30; B29C 41/28; B29C 2063/027; B29L 2007/008; B29L 2031/34

(57) ABSTRACT

A method of manufacturing a waterproof heating mat includes pouring a first amount of a liquid polymer onto a surface of a conveyer belt; partially curing the first amount of liquid polymer to form a first layer; placing a heating film on the first layer such that at least one side of the heating film is covered by the first layer; pouring a second amount of the liquid polymer onto the heating element and the first layer; and curing the second amount of liquid polymer to form a second layer, the second layer contacting the first layer to at least partially encapsulate the heating element between the first layer and the second layer.

### CROSS-REFERENCE TO RELATED APPLICATIONS

This application claims the benefit of the filing date of U.S. Provisional Patent Application No. 63/526,026 filed Jul. 11, 2023, the disclosure of which is hereby incorporated herein by reference.

### BACKGROUND OF THE INVENTION

Waterproof heating mats are used in many cold climates to heat sidewalks, driveways, walkways, and other surface level pathways to melt snow and ice and provide comfort to people and animals via heat radiation. In turn, the mats make walking and other forms of transportation, such as using wheelchairs, bicycles, and scooters, safer in colder climates and more accessible to the general population.

Thin and flexible heating films are often used to create waterproof heating mats. These films often include heating elements such as rows of carbon ink positioned between bus bars extending longitudinally across the film. These heating films can be glued to various waterproof mats to result in a waterproof heating mat that is suitable for outdoor use in various climates. Such manufacturing methods are not without drawbacks.

Gluing heating films to pre-existing waterproof mats limits the size and shape of the resulting mat to that of the pre-existing mat, with little room for variation. This may result in a heating film covering only a small percentage of the surface area of the resulting waterproof mat, which causes heating inefficiencies. Gluing also creates potential failure modes if inconsistent glue beads are applied to multiple mats, which could cause some mats to leak such that the heating films become damaged. Further, some glue may hinder the performance of the heating elements within the heating films and may weaken over time due to the high temperatures produced by the heating elements. Accordingly, an improved method of manufacturing waterproof heating mats without gluing is desired.

### BRIEF SUMMARY OF THE INVENTION

According to one aspect of the present disclosure, a method of manufacturing a waterproof heating mat comprises: dispensing a first amount of a liquid polymer onto a surface of a conveyer belt; partially curing the first amount of liquid polymer to form a first layer; placing a heating film on the first layer such that at least one side of the heating film is covered by the first layer; dispensing a second amount of the liquid polymer onto the heating element and the first layer; and curing the second amount of liquid polymer to form a second layer, the second layer contacting the first layer to at least partially encapsulate the heating element between the first layer and the second layer.

In another aspect, the method further comprises allowing the first layer to fully cure after placing the heating film.

In a different aspect, the method further comprises depositing the first and second amounts of liquid polymer under a squeegee bar to create a uniform shape waterproof heating mat.

In another aspect, the method further comprises adjusting a height of the squeegee bar to adjust a thickness of the resulting first and second layers.

In yet another aspect, the method further comprises collecting the first layer and the heating film on a spool positioned at the end of the conveyer belt.

In a further aspect, the method further comprises redistributing the first layer and the heating film from the spool to a beginning of the conveyer belt.

In a different aspect, the curing step includes adhering a first border region of first layer to a second border region of the second layer, the first and second border regions extending laterally wider than a width of the heating film.

In another aspect, the curing steps include activating the conveyer belt such that the first and second layers cure as the surface of the conveyer belt moves between a beginning position and an end position.

In a further aspect, the dispensing steps include pouring respective first and second amounts of liquid vinyl.

In yet another aspect, the method further comprises melting the polymer in a drum positioned adjacent to the conveyer belt.

According to another aspect of the disclosure, a method of manufacturing a waterproof heating mat comprises: dispensing a first layer of liquid vinyl on a first end of a moving conveyer belt such that the first layer at least partially cures between the first end and a second end; placing a heating film on the first layer while the first layer is curing; dispensing a second layer of liquid vinyl onto the conveyer belt; partially curing the second layer on the moving conveyer belt between the first end and the second; and placing the heating film in the curing second layer to at least partially encapsulate the heating film within the first and second layers.

In a different aspect, the placing step includes placing the heating film on the first layer while the first layer is between 50%-60% cured.

In another aspect, the placing the heating film step includes positioning the heating film upside down such that the first layer faces upward and the heating film faces downward.

In a further aspect, the placing the heating film step includes placing the heating film when the second layer is between 50%-60% cured.

In another aspect, the method further comprises aligning a border of the first layer with a border of the second layer.

In a different aspect, the method further comprises adhering the second layer to the first layer to form the waterproof heating mat and fully encapsulate the heating film within the first and second layers.

In another aspect, the method further comprises cutting the waterproof heating mat laterally across the width of the waterproof heating mat.

In a further aspect, the method further comprises cutting a pocket into a longitudinal end of the waterproof heating mat such that the heating film is exposed within the pocket.

In another aspect, the method further comprises running a wire to the heating film within the pocket.

In yet another aspect, the method further comprises sealing a perimeter of the first and second layers of the waterproof heating mat with a bead of liquid vinyl such that the wire extends through the bead to form a waterproof connection.

According to another aspect of the present disclosure, a waterproof heating mat comprises: a base layer of solidified vinyl; a top layer of solidified vinyl, the top layer positioned over and adhered to the base layer to form an open pocket defined by a periphery of the base layer; and a heating film, the heating film positionable within the pocket and adhered to the base layer and the top layer.

In another aspect, the periphery of the base layer is larger than a periphery of the heating film.

In a different aspect, the top layer is adhered to the base layer by a bead of vinyl.

In a further aspect, the mat further comprises a wire extending from the heating film and through the pocket.

In another aspect, the mat further comprises a limiting thermocouple within the pocket.

### BRIEF DESCRIPTION OF THE DRAWINGS

A more complete appreciation of the subject matter of the present disclosure and the various advantages thereof can be realized by reference to the following detailed description, in which reference is made to the following accompanying drawings:

FIG. 1 is a side view of a conveyer belt system for manufacturing waterproof heating mats according to one embodiment of the present disclosure.

FIG. 2 is a side view of a conveyer belt system for manufacturing waterproof heating mats according to another embodiment of the present disclosure.

FIG. 3 is a side view of a conveyer belt system for manufacturing waterproof heating mats according to another embodiment of the present disclosure.

FIG. 4 is a perspective view of the roller and heating film of FIG. 3.

FIG. 5 is a perspective view of a heating film according to one embodiment of the present disclosure.

FIG. 6 is an exploded side view of a waterproof heating mat created using any of the manufacturing methods of the present disclosure.

FIG. 7 is a top view of a heating film encased within a first layer of cured vinyl according to one embodiment of the present disclosure.

FIG. 8 is another top view of the heating film encased within a first layer of cured vinyl of FIG. 7.

FIG. 9 is a side view of the heating film encased within a first layer of cured vinyl of FIG. 7.

FIG. 10 is a perspective view of a waterproof heating mat created using any of the manufacturing methods of the present disclosure.

FIG. 11 is a perspective view of a portion of the waterproof heating mat of FIG. 10 that has been opened to create a pocket.

### DETAILED DESCRIPTION

Reference will now be made in detail to the various embodiments of the present disclosure illustrated in the accompanying drawings. It should be noted that the drawings are in simplified form and are not drawn to precise scale. Additionally, the term “a,” as used in the specification, means “at least one.” The terminology includes the words above specifically mentioned, derivatives thereof, and words of similar import. Although at least two variations are described herein, other variations may include aspects described herein combined in any suitable manner having combinations of all or some of the aspects described.

In describing preferred embodiments of the disclosure, reference will be made to directional nomenclature used in describing components with respect to a direction in which gravity acts on an object. It is noted that this nomenclature is used only for convenience and that it is not intended to be limiting with respect to the scope of the present disclosure. As used herein, when referring to components, the term “up” means generally toward a ceiling or a direction against a gravitational force, and the term “down” means toward the ground or a direction with a gravitational force.

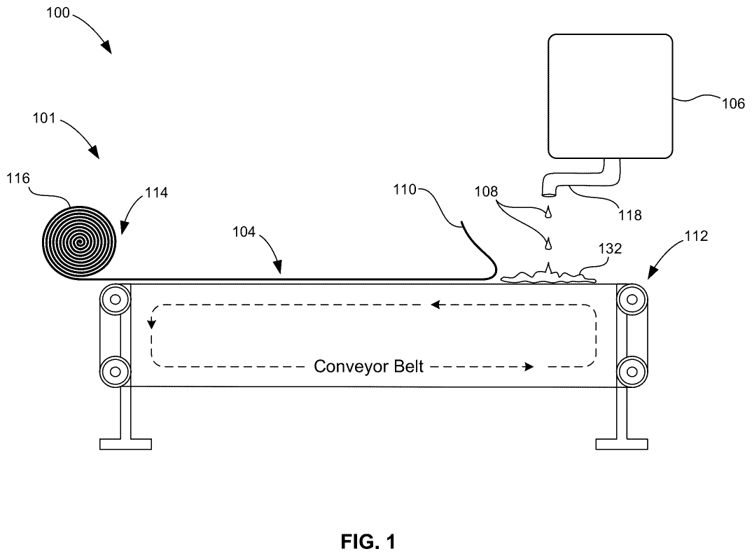

FIG. 1 illustrates a method 100 for manufacturing a waterproof heating mat 102. A conveyer belt 104 is operated such that a drum 106 at least partially filled with a liquid polymer, such as liquid vinyl 108, is opened to dispense the liquid vinyl 108 onto the conveyer belt 104. A squeegee bar 110 is configured to uniformly distribute the liquid vinyl 108 such that it cures evenly as it travels along the length of the conveyer belt 104 from a first end 112 to a second end 114. Each component will be described in detail herein.

FIGS. 1-3 illustrate a conveyer belt system 101 according to various embodiments of the present disclosure. Conveyer belt system 101 includes a conveyer belt 104 that may be any conveyer belt type known in the art, such as a flat belt, modular belt, and the like. Conveyer belt 104 may be secured to a floor within a plant or other manufacturing facility or it may be moveable. Conveyer belt 104 extends from a first end 112 to a second end 114. First end 112 includes a liquid drum 106 or liquid reservoir that is configured to dispense a liquid polymer, such as liquid vinyl 108, onto the conveyer belt 104. The second end 114 includes a roller 116 or similar device for collecting and rolling layers of cured vinyl. As depicted, the conveyer belt 104 turns in a counterclockwise direction such that the conveyer belt 104 moves from the first end 112 toward the second end 114. It is foreseeable that other conveyer belt arrangements may be utilized such that the liquid drum 106 and roller 116 may be positioned at other locations across the conveyer belt 104.

The drum 106 may be any drum known in the art that is openable and closeable to allow a liquid within drum 106 to smoothly flow out of drum 106. As such, drum 106 may have a plurality of air holes to allow for a smooth exiting flow of liquid. Drum 106 may be formed of various materials with material properties that allow drum 106 to withstand the high heat of the liquid polymer contained therein. Drum 106 may further have a heating element for melting a polymer to a suitable liquid form, or it may be configured to receive the liquid polymer from another apparatus. Drum 106 may have an outlet 118 in the form of a nozzle that guides the liquid contained within drum 106 onto a surface of conveyer belt 104 Drum 106 may be removable from conveyer belt 104 or may be affixed to conveyer belt 106.

A squeegee bar 110 is attached to a first end 112 of conveyer belt 104 near drum 106. Squeegee bar 110 allows for an even and uniform distribution of the liquid vinyl 108 across an upper surface of conveyer belt 104. Squeegee bar 110 is preferably adjustable to vary the thickness of the resulting layer of cured vinyl. For applications in which a thicker waterproof heating mat 142 is desired, squeegee bar 110 may be raised to allow for a thicker layer of cured vinyl to form. Likewise, for applications in which a thin waterproof heating mat 142 is desired, squeegee bar 110 may be lowered to result in a thinner layer of cured vinyl. The width of squeegee bar 110 may also be adjusted via telescoping sections or adding additional sections to account for wider waterproof heating mats 142. As such, squeegee bar 110 is fully adjustable in at least the height and width directions to result in different waterproof heating mats 142. Although a squeegee bar 110 is described herein, other devices that provide for a uniform distribution of liquid vinyl 108 onto conveyer belt 104 may be utilized.

Conveyer belt 104 is preferably dimensioned to accommodate various sizes of waterproof heating mats 142. Thus, the width of conveyer belt 104 may correspond to the width of waterproof heating mats 142 that cover standard sidewalks. Alternatively, the width of conveyer belt 104 may correspond to a larger waterproof heating mat 142, such as the width of a waterproof heating mat that covers a driveway. This larger conveyer belt may accommodate both driveway and sidewalk-sized waterproof heating mats 142, and various squeegee bars 110, fences, and jigs may be utilized with conveyer belt 104 to adjust the dimensions of the curing vinyl to create the desired waterproof heating mat 142.

In addition to the width of conveyer belt 104 corresponding to various sizes of waterproof heating mats 142, the length of conveyer belt 104 may also correspond to different waterproof heating mats 142 depending on particular applications. Conveyer belt 104 is preferably long enough to allow liquid vinyl 108 to cure from a liquid to a solid between the first end 112 and second end 114. To facilitate the curing process, various ovens, heaters, fans, and the like may be placed along the length of conveyer belt 104. Conveyer belt 104 may be long enough to accommodate a single waterproof heating mat 142 that is designed for a continuous and lengthy application, such as covering an entire pathway. Alternatively, a long conveyer belt 104 may be utilized that creates many waterproof heating mats 142 that are cut to various sizes.

A collection device, such as a roller 116 or the like, may be positioned at the second end 114 of conveyer belt 104 to collect sheets of vinyl that have solidified during the curing process. Such a roller 116 prevents the sheets of solidified vinyl from falling off conveyer belt 104 as the belt flips upside down between the second end 114 and first end 112. Roller 116 may be used in conjunction with additional conveyer belt systems to perform additional pouring steps or to return the sheets of solidified vinyl back to the first end 112 of conveyer belt 104.

The waterproof heating mat 142 is preferably formed by encasing a heating film 120 within layers of liquid vinyl 108 that form a waterproof barrier around the heating film 120. While liquid vinyl 108 is described herein to form waterproof heating mat 142, it is appreciated that other materials and combinations of materials may be utilized to achieve a waterproof heating mat that has desirable characteristics such as a low-cost, case in manufacturing, waterproofing capabilities, flexibility, and the like. Such materials include other thermoplastic materials such as a nitrilo-based polyolefin (TPO or TPE-O), rubber, polycarbonate, high-density polyethylene (HDPE), polyvinyl chloride (PVC), and the like.

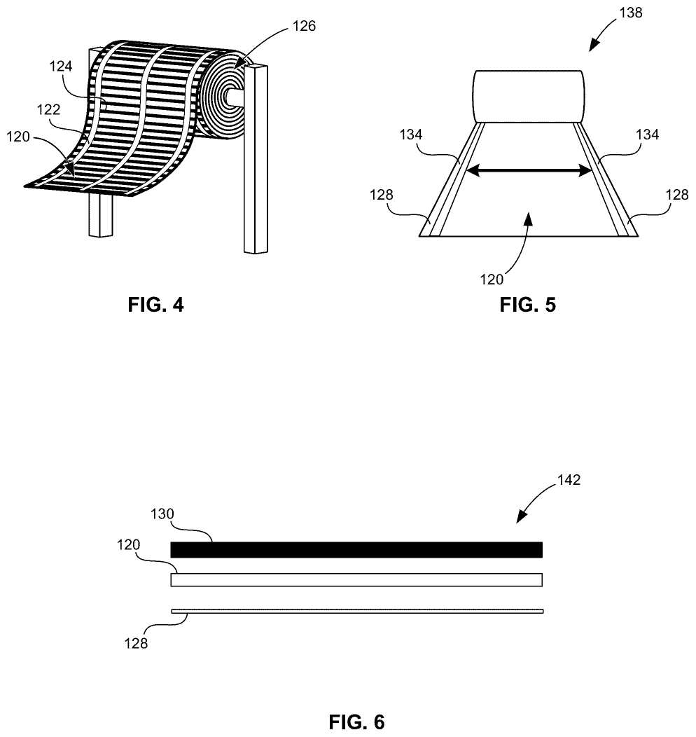

FIGS. 4-5 depict a heating film 120 according to one embodiment of the present disclosure. Heating film 120 may be any standard heating film known in the art. Heating film 120 preferably is elongated and flexible such that it can be manipulated according to the bends in the solidified vinyl encasing heating film 120 to accommodate various surface types in use. Heating film 120 may have at least one bus bar 122 extending longitudinally along the length of film 120 and various rows of carbon ink 124 that act as heating elements. A wire may be run from bus bar 122 to an electrical outlet, battery, or other power source to power the heating film 120. Various spools 126 (illustrated in FIG. 4) may be utilized to hold rolls of heating films 120 near conveyer belt 104 to release heating film 120 into the curing liquid vinyl. Such a process may be automated or require an operator who manually performs the task. It is envisioned that other types of readily available heating films may be utilized in addition to heating film 120 described herein. Heating film 120 may also be a flexible heating film including a wire alloy wound into a circuit and laminated in a polyester or mylar film. Other heating films known in the art may be implemented with the manufacturing method described herein, and the thickness and size of layers 128, 130 may be adjusted in accordance with the particular heating film implemented.

A method of manufacturing a waterproof heating mat 142 is described herein. It is appreciated that each step in the manufacturing process may be facilitated by human operators, may be entirely autonomous and use robots and other automated manufacturing equipment, or a combination of the two. An elongated conveyer belt 104 is first provided that is configured to form a continuous waterproof heating mat 142. Such a conveyer belt 104 includes a drum 106 at a first end 112 configured to hold liquid vinyl 108 (or similar polymers) to form first and second layers 128, 130 of cured vinyl on conveyer belt 104. Conveyer belt 104 extends a distance between first end 112 and a second end 114 that allows liquid vinyl 108 to at least partially cure as it travels between the first end 112 and second end 114.

Drum 106 may then be activated to melt vinyl to a viscosity that allows it to be poured onto conveyer belt 104 to form layers of cured vinyl. Alternatively, the vinyl may be melted in a separate apparatus and transferred to drum 106 to be distributed onto conveyer belt 104. The viscosity of the vinyl may be adjusted via temperature changes, additives in the liquid vinyl 108, or other methods to result in varying thickness of layers of cured vinyl. Drum 106 is preferably positioned above conveyer belt 104 such that the liquid vinyl 108 can flow directly onto conveyer belt 104 through an outlet 118 to form a globule 132 of liquid vinyl 108.

Before or while the liquid vinyl 108 flows onto the first end 112 of conveyer belt 104, the conveyer belt may be activated to move in a direction such that a top surface of the conveyer belt faces up between the first and second ends 112, 114. As illustrated in FIGS. 1-3, this direction is counterclockwise. The liquid vinyl 108 forms a globule 132 beneath the drum 106 and that globule 132 passes under an adjustable squeegee bar 110. The adjustable squeegee bar 110 may be set to a height that corresponds with a desired thickness of the resulting layer of cured vinyl. Further guides or jigs may be positioned along the conveyer belt 104 to cause the liquid vinyl to cure in a particular shape (e.g., in a square or rectangular shape). The length and width of the result layers of cured vinyl are preferably larger than the length and width of the heating film 120 such that the heating film 120 will be fully encased by the layers of cured vinyl to form a watertight barrier. As such, there may be a border 134 of cured vinyl that extends past the edges of heating film 120.

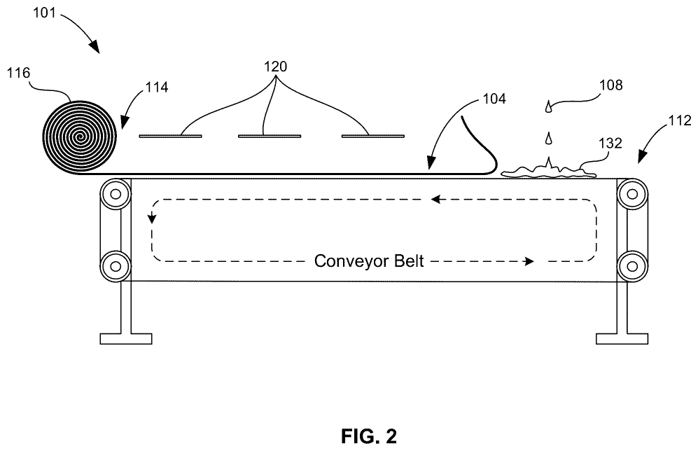

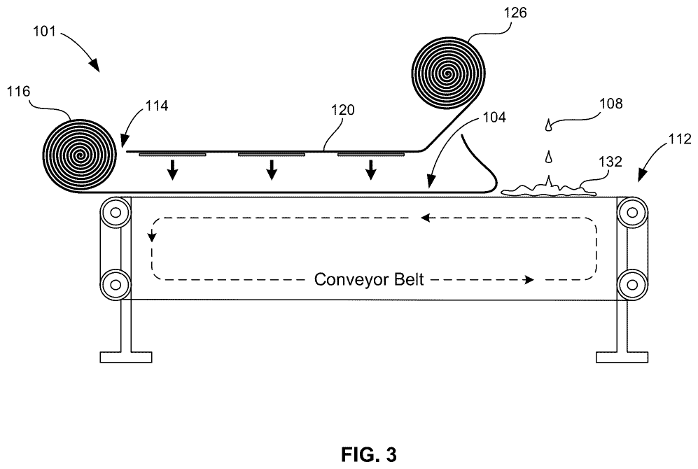

As the conveyer belt moves, it causes the liquid vinyl 108 to pass under squeegee bar 110 and begin curing in a long, continuous first layer 128 until the drum 106 stops dispensing liquid vinyl 108. As the liquid vinyl 108 is curing, heating film 120 may be placed over the top of the first layer 120. This placing step may occur when the first layer 128 is at least partially cured, ideally 40-60% cured. Heating film 120 may be precut into segments and placed by hand or robot into first layer 128, such as the placement illustrated in the embodiment of FIG. 2. Alternatively, as illustrated in the embodiment of FIG. 3, heating film 120 may be placed on a spool 126 at the first end 112 of conveyer belt 104 and be unrolled at a velocity that matches the velocity of the conveyer belt 104.

The heating film 120 may be placed onto the first layer 128 of curing vinyl such that the heating film 120 is not fully submerged within the liquid vinyl 108. As such, the heating film 120 may be gently set on the first layer 128 of curing vinyl and not pressed into the first layer 128 so that an upper surface 136 of heating film 120 is not covered in vinyl. Alternatively, the heating film 120 may be fully submerged within the first layer 128 of curing vinyl.

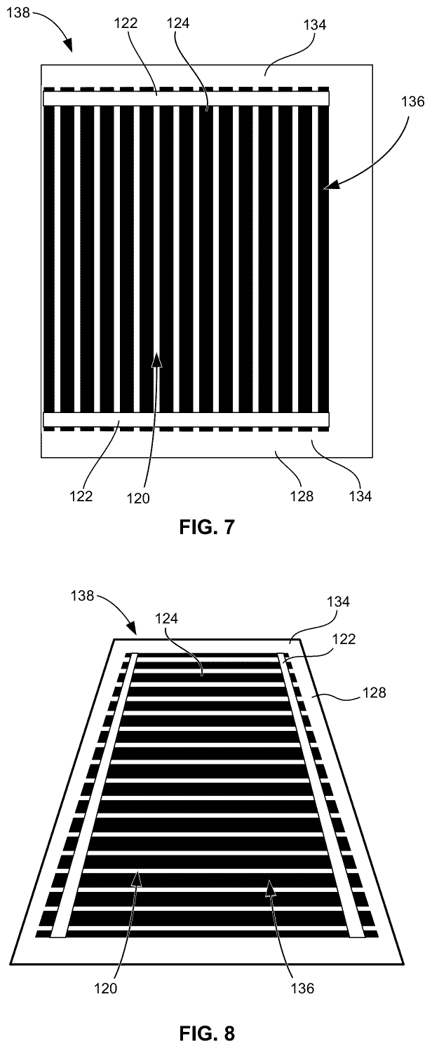

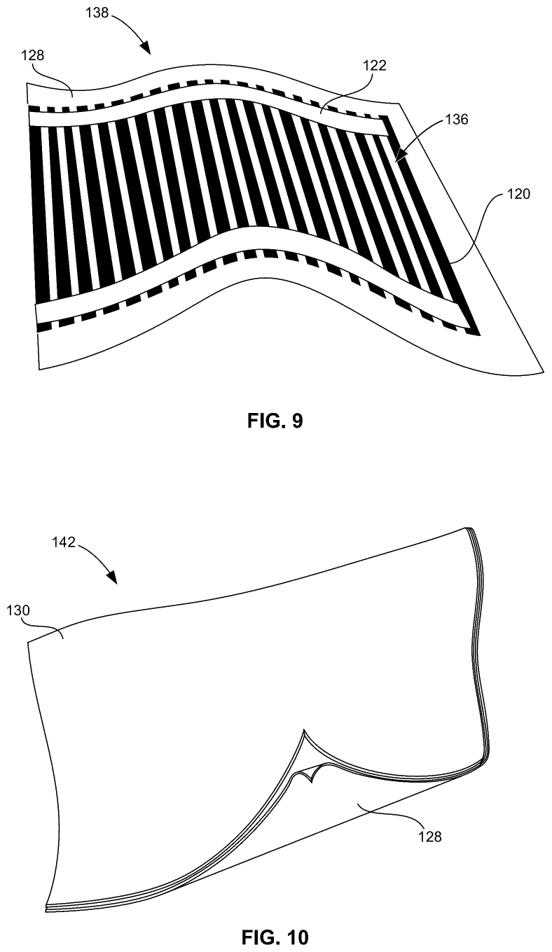

As the first layer 128 of curing vinyl continues to solidify between the first end 112 and second end 114 of conveyer belt 104, the heating film 120 adheres to the curing vinyl to form a watertight seal on one side of the first layer 128 of curing vinyl. Once fully cured, the resulting single-sided heating film construct 138 (illustrated in FIGS. 5 and 7-9) may be collected onto a roller 116 at the second end 114 of conveyer belt 104. Once the single-sided heating film construct 138 has been collected, it can be stored or immediately be prepared for the step of pouring a second layer 130 of liquid vinyl 108 and adhering the single-sided heating film construct 138 to the second layer 130 to fully encapsulate heating film 120. The single-sided heating film construct 138 may be transported to a first end 112 of conveyer belt 104 or to a position between the first and second ends 112, 114 depending on the method utilized for pouring the second layer 130.

The second layer 130 of liquid vinyl 108 may be poured using the same pouring techniques described for the first layer 128 of liquid vinyl 108. Second layer 130 of liquid vinyl 108 may be poured onto conveyer belt 104 and pass under squeegee bar 110 after the single-sided heating film construct 138 has been removed from conveyer belt 104. Squeegee bar 110 is preferably adjusted such that the resulting second layer 130 has the same or substantially similar dimensions as the first layer 128. While second layer 130 is curing, the single-sided heating film construct 138 may be positioned upside down such that the heating film 120 is facing down. The heating film 120 may then be placed directly into the curing second layer 130 such that the first layer 128 fully adheres to the second layer 130 with the heating film 120 in between the first and second layers 128. This placing step may occur when the second layer is between 30-70% cured. Such a placing step may be accomplished by hand or by robot to ensure a proper alignment between a border 134 of the first layer 128 and a border 134 of the second layer 130.

In another embodiment, a waterproof heating mat 142 may be manufactured by feeding the single-sided heating film construct 138 through the first end 112 of conveyer belt 104 and dispensing a second layer 130 of liquid vinyl 108 above the heating film 120 to fully encapsulate heating film 120 and form waterproof heating mat 142. This may be accomplished by feeding the single-sided heating film construct 138 onto the first end 112 of conveyer belt 104 from a roller or spool such that the heating film 120 faces up and away from the surface of the conveyer belt 104 and passes under squeegee bar 110. The liquid vinyl 108 may then be poured directly over the top of the heating film 120.

Continuing with this embodiment, after pouring the second layer 130, the second layer 130 of liquid vinyl 108 cures in the same curing manner as the first layer 128. As such, the second layer 130 will fuse to the first layer 128 between the first end 112 and second end 114 of conveyer belt 104. This fusion results in a waterproof casing around the heating film 120 that creates a waterproof heating mat 142. Further, the fusion specifically takes place around the borders 134, 135 of the first and second cured layers 128, 130, respectively, such that the encased heating film 120 is operable and protected. Waterproof heating mat 142 may then be collected onto a roller 116 for storage or transportation purposes or may be cut to size on conveyer belt 104. Due to the carbon ink 124 extending transverse to the longitudinal axis of the heating film 120, waterproof heating mat 142 may be laterally cut at any location along the longitudinal axis of the waterproof heating mat 142 without damaging the underlying heating film 120.

In alternative embodiments, second layer 130 of liquid vinyl 108 may be poured sequentially shortly after the first layer 128 of liquid vinyl 108 is poured. This may be accomplished by having multiple drums positioned adjacent to the same conveyer belt such that no collection devices like rollers or spools are required to collect the first layer 128 and redistribute the first layer 128 back to the first end 112 of conveyer belt 104. Rather, the first layer 128 of liquid vinyl 108 may be poured at the first end 112 of conveyer belt 104 and the heating film 120 may subsequently be placed on the first layer 128. Then, at a position between the first and second ends 112, 114, a second drum may dispense a second amount of liquid vinyl 108 to cover the heating film 120 and first layer 128. In other embodiments, additional layers of material may be placed above or beneath first and second layers 128, 130. Such materials may include thermoplastic materials like nitrol-based polyolefin (TPO or TPE-O), rubber, polycarbonate, high-density polyethylene (HDPE), polyvinyl chloride (PVC), and the like. These additional layers may be formed using similar methods to those described herein for the first and second layers 128, 130 of vinyl, or may be attached to first and second layers 128, 130 after the additional layers have already cured. The structure of the additional layers may be modified to achieve a desired characteristic for the resulting waterproof heating mat. To facilitate the curing processes, various pressure plates may be implemented along conveyer belt 104 to press down on the layers of curing liquid. One having ordinary skill will appreciate that the temperatures and viscosities of the liquid plastics may be modified in order to achieve a desired layer implemented within a waterproof heating mat.

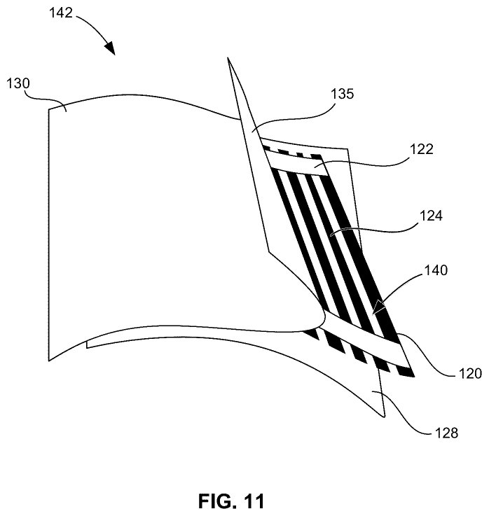

After waterproof heating mat 142 has fully cured and been cut to an appropriate size, additional cuts may be made to open a pocket 140 (illustrated in FIG. 11) within the waterproof heating mat 142 at one of the longitudinal ends of waterproof heating mat 142 to allow a wire to be run to heating film 120 to provide power thereto. In addition to a wire, other heating elements that may serve to aid or limit the heating capacity of heating film 120, such as a limiting thermocouple, may be placed within pocket 140. Pocket 140 may be closed using a bead of liquid vinyl placed around a perimeter of the first and second vinyl layers 128, 130, by gluing, or the like. In alternative embodiments, a wire may be connected to heating film 120 during the curing steps such that an additional pocket is not required.

After the waterproof heating mat 142 has been manufactured, various textures and additives may be applied to the first and second vinyl layers 128, 130 to aid in grip, water runoff, visibility, and the like. The resulting waterproof heating mat is flexible and can be set on a variety of terrains and surfaces to accommodate the topography of that surface.

Furthermore, although the invention disclosed herein has been described with reference to particular features, it is to be understood that these features are merely illustrative of the principles and applications of the present invention. It is therefore to be understood that numerous modifications, including changes in the sizes of the various features described herein, may be made to the illustrative embodiments and that other arrangements may be devised without departing from the spirit and scope of the present invention. In this regard, the present invention encompasses numerous additional features in addition to those specific features set forth in the paragraphs below. Moreover, the foregoing disclosure should be taken by way of illustration rather than by way of limitation as the present invention is defined in the examples of the numbered paragraphs, which describe features in accordance with various embodiments of the invention, set forth in the paragraphs below.

1. A method of manufacturing a waterproof heating mat, the method comprising:
dispensing a first amount of a liquid polymer onto a surface of a conveyer belt;
partially curing the first amount of liquid polymer to form a first layer;
placing a heating film on the first layer such that at least one side of the heating film is covered by the first layer;
dispensing a second amount of the liquid polymer onto the heating element and the first layer; and
curing the second amount of liquid polymer to form a second layer, the second layer contacting the first layer to at least partially encapsulate the heating element between the first layer and the second layer.

2. The method of claim 1, further comprising allowing the first layer to fully cure after placing the heating film.

3. The method of claim 1, further comprising depositing the first and second amounts of liquid polymer under a squeegee bar to create a uniform shape waterproof heating mat.

4. The method of claim 3, further comprising adjusting a height of the squeegee bar to adjust a thickness of the resulting first and second layers.

5. The method of claim 1, further comprising collecting the first layer and the heating film on a spool positioned at the end of the conveyer belt.

6. The method of claim 5, further comprising redistributing the first layer and the heating film from the spool to a beginning of the conveyer belt.

7. The method of claim 1, wherein the curing step includes adhering a first border region of first layer to a second border region of the second layer, the first and second border regions extending laterally wider than a width of the heating film.

8. The method of claim 1, wherein the curing steps include activating the conveyer belt such that the first and second layers cure as the surface of the conveyer belt moves between a beginning position and an end position.

9. The method of claim 1, wherein the dispensing steps include pouring respective first and second amounts of liquid vinyl.

10. The method of claim 1, further comprising melting the polymer in a drum positioned adjacent to the conveyer belt.

11. A method of manufacturing a waterproof heating mat, the method comprising:
dispensing a first layer of liquid vinyl on a first end of a moving conveyer belt such that the first layer at least partially cures between the first end and a second end;
placing a heating film on the first layer while the first layer is curing;
dispensing a second layer of liquid vinyl onto the conveyer belt;
partially curing the second layer on the moving conveyer belt between the first end and the second; and
placing the heating film in the curing second layer to at least partially encapsulate the heating film within the first and second layers.

12. The method of claim 11, wherein the placing step includes placing the heating film on the first layer while the first layer is between 50%-60% cured.

13. The method of claim 11, wherein the placing the heating film step includes positioning the heating film upside down such that the first layer faces upward and the heating film faces downward.

14. The method of claim 13, wherein the placing the heating film step includes placing the heating film when the second layer is between 50%-60% cured.

15. The method of claim 11, further comprising aligning a border of the first layer with a border of the second layer.

16. The method of claim 11, further comprising adhering the second layer to the first layer to form the waterproof heating mat and fully encapsulate the heating film within the first and second layers.

17. The method of claim 16, further comprising cutting the waterproof heating mat laterally across the width of the waterproof heating mat.

18. The method of claim 16, further comprising cutting a pocket into a longitudinal end of the waterproof heating mat such that the heating film is exposed within the pocket.

19. The method of claim 18, further comprising running a wire to the heating film within the pocket.

20. The method of claim 19, further comprising sealing a perimeter of the first and second layers of the waterproof heating mat with a bead of liquid vinyl such that the wire extends through the bead to form a waterproof connection.

21. A waterproof heating mat comprising:
a base layer of solidified vinyl;
a top layer of solidified vinyl, the top layer positioned over and adhered to the base layer to form an open pocket defined by a periphery of the base layer; and
a heating film, the heating film positionable within the pocket and adhered to the base layer and the top layer.

22. The mat of claim 21, wherein the periphery of the base layer is larger than a periphery of the heating film.

23. The mat of claim 22, wherein the top layer is adhered to the base layer by a bead of vinyl.

24. The mat of claim 23, further comprising a wire extending from the heating film and through the pocket.

25. The mat of claim 21, further comprising a limiting thermocouple within the pocket.
